(19) United States
(12) Patent Application Publication
(10) Pub. No.: US 2019/0028296 A1
(43) Pub. Date: Jan. 24, 2019

(54) PROMPTING ASSEMBLY IN TOILET PAPER RECEPTACLE AND SMART HOME SYSTEM

(71) Applicants: Fu Tai Hua Industry (Shenzhen) Co., Ltd., Shenzhen (CN); HON HAI PRECISION INDUSTRY CO., LTD., New Taipei (TW)

(72) Inventor: ZHI-QIANG YU, Shenzhen (CN)

(21) Appl. No.: 15/853,916

(22) Filed: Dec. 25, 2017

(30) Foreign Application Priority Data
Jul. 19, 2017 (CN) 201710592247.0

(51) Int. Cl. H04L 12/28; G01C 19/42; H04W 4/38; A47K 10/22

(52) U.S. Cl. CPC H04L 12/2827; G01C 19/42; A47K 2010/389; A47K 10/22; H04W 4/38

(57) ABSTRACT

A toilet paper receptacle includes a spindle configured to hold a roll of toilet paper and a prompting assembly. The prompting assembly includes a sensor located on the spindle and configured to sense a quantity of rotations of the spindle, a controller electrically coupled to the sensor and configured to calculate a total number of rotations and compare the total number of rotations to a first preset value, and a prompter electrically coupled to the controller and controlled by the controller to output a signal when the total number of rotations is greater than the first preset value.

### CROSS-REFERENCE TO RELATED APPLICATIONS

This application claims priority to Chinese Patent Application No. 201710592247.0 filed on Jul. 19, 2017, the contents of which are incorporated by reference herein.

### FIELD

The subject matter herein generally relates to a prompting assembly for a toilet paper receptacle for prompting a user to replace the toilet paper.

### BACKGROUND

Generally, when a toilet paper roll dispenses paper from a receptacle, a user cannot see how much toilet paper is left on the roll.

### BRIEF DESCRIPTION OF THE DRAWINGS

Implementations of the present disclosure will now be described, by way of example only, with reference to the attached figures.

FIG. 1 is a diagram of components of an exemplary embodiment of a prompting assembly.

FIG. 2 is a diagram of components of an exemplary embodiment of a smart home system using the prompting assembly of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected.

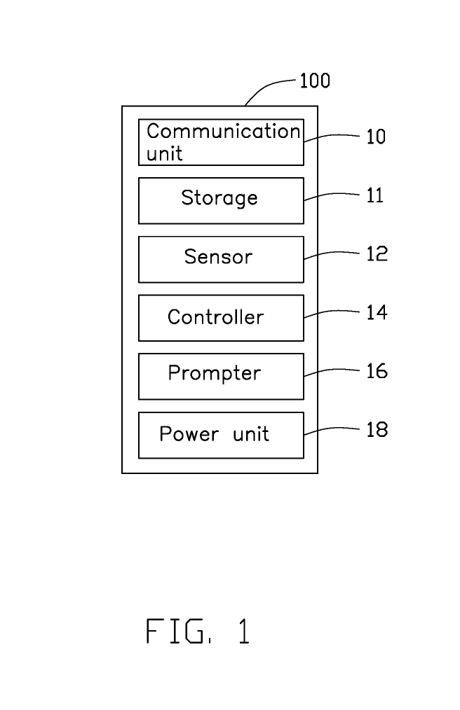

FIG. 1 illustrates an embodiment of a prompting assembly 100. In at least one embodiment, the prompting assembly 100 can be installed in a toilet paper receptacle for determining a usage status of a roll of toilet paper. The prompting assembly 100 can include a communication unit 10, a storage 11, a sensor 12, a controller 14, a prompter 16, and a power unit 18. The communication unit 10, the storage 11, the sensor 12, the prompter 16, and the power unit 18 are electrically coupled to the controller 14. The power unit 18 supplies power to the communication unit 10, the storage 11, the sensor 12, the controller 14, and the prompter 16.

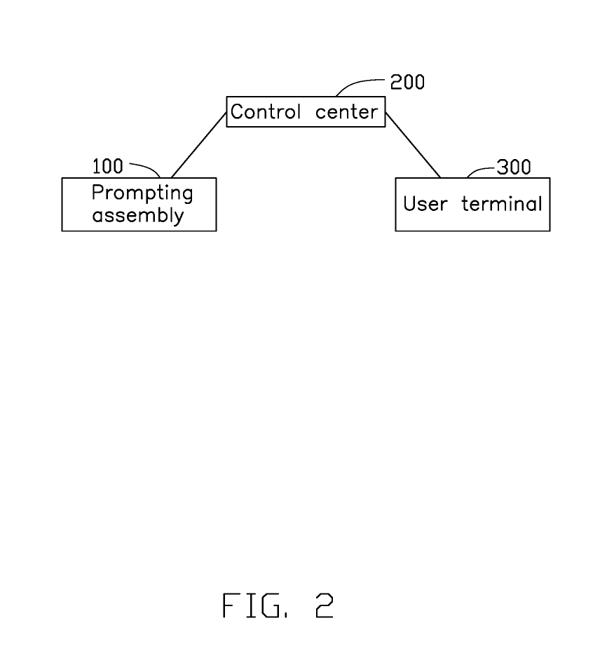

Referring to FIG. 1 and FIG. 2, the communication unit 10 is in communication with a user terminal 300 through a control center 200. The control center 200 can be a computer, a mobile phone, a gateway, a local server, or a cloud server, for example. The user terminal 300 can be a mobile phone, a tablet computer, or any portable electronic device, for example. The control center 200 is in communication with at least the prompting assembly 100. In other embodiments, the control center 200 can also be in communication with a television, a refrigerator, a washing machine, light assemblies, or other home appliances to form a smart home system, and the smart home system can be controlled through the user terminal 300.

In at least one embodiment, the sensor 12 is a gyroscope. The sensor 12 can sense a quantity of rotations of a spindle of the toilet paper receptacle. As the toilet paper roll is spun to dispense toilet paper, the spindle rotates with the toilet paper roll. Thus, a quantity of rotations of the toilet paper roll is equal to the quantity of rotations sensed by the sensor 12. The sensor 12 can obtain the quantity of rotations of the toilet paper roll from the quantity of rotations of the spindle, and send the quantity of rotations to the controller 14 and the storage 11. The controller 14 can compare a total number of rotations to a first preset value.

The storage 11 can store a second preset value representing an initial number of rotations of the toilet paper roll. In at least one embodiment, a user can set the second preset value in the user terminal 300. In another embodiment, the user can use the user terminal 300 to set the second preset value and/or the quantity of rotations according to a usage status of the toilet paper roll. In detail, the user terminal 300 sends the second preset value and/or the quantity of rotations to the control center 200, and the control center 200 sends the second preset value and/or the quantity of rotations to the controller 14 and/or the storage 11 through the communication unit 10.

The controller 14 can calculate the total number of rotations of the toilet paper roll according to a total number of rotations of the spindle sensed by the sensor 12 and compare the total number of rotations to the first preset value. The controller 14 can control the communication unit 10 and/or the prompter 16 according to a result of comparison. When the user uses the user terminal 300 to set the quantity of rotations according to actual use of the toilet paper roll, the controller 14 can calculate the total number of rotations starting from the quantity of rotations set by the user. When the controller 14 calculates that the total number of rotations is greater than the first preset value, the controller 14 controls the communication unit 10 to send a control command to the control center 200 to control the control center 200 to send a message to the user terminal 300. The first preset value is smaller than the second preset value. In at least one embodiment, the user can set the value of the first preset value. For example, the first preset value can be 90% of the second preset value. The message sent by the control center 200 to the user terminal 300 can at least include a warning that the toilet paper is not enough. In another embodiment, the communication unit 10 can be in communication with the user terminal 300, the controller 14 can control the communication unit 10 to directly send the message to the user terminal 300, and the user terminal 300 can directly send the second preset value and/or the quantity of rotations through the communication unit 10 to the controller 14 and/or the storage 11.

When the controller 14 calculates that the total number of rotations is greater than the first preset value, the controller 14 further can control the prompter 16 to emit a signal to prompt the user to check the toilet paper roll. In at least one embodiment, the prompter 16 is an LED, and the signal can be a light emitted by the LED.

The power unit 18 can be a battery or a power plug that can plug into an external power source to provide power for the prompting assembly 100.

The user can use the user terminal 300 to set and send the second preset value and/or the quantity of rotations according to actual usage of the toilet paper roll to the control center 200, and the control center 200 can send the second preset value and/or the quantity of rotations to the controller 14 and/or the storage 11 through the communication unit 10. When the toilet paper is used, the sensor 12 senses the quantity of rotations and sends the quantity of rotations to the controller 14 and the storage 11. When the controller 14 calculates that the total number of rotations is greater than the first preset value, the controller 14 controls the communication unit 10 to send the control command to the control center 200 to control the control center 200 to send the message to the user terminal 300. At the same time, the controller 14 can control the prompter 16 to emit the signal to prompt the user to check the toilet paper roll.

It should be understood that when the control center 200 is in communication with a plurality of prompting assemblies 100 and/or a plurality of smart home appliances as well as a plurality of user terminals 300, when the control center 200 receives a control command from any of the prompting assemblies 100 and/or any of the smart home appliances, the control center 200 can be set to immediately send a message to the corresponding user terminal 300 upon receiving a control command, or the control center 200 can be set to periodically send messages to the corresponding user terminals 300 according to the control commands.

In at least one embodiment, the prompting assembly 100 can be received in a casing (not shown) to prevent water damage to the prompting assembly 100.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A prompting assembly comprising:
a sensor configured to sense a quantity of rotations;
a controller electrically coupled to the sensor and configured to calculate a total number of rotations and compare the total number of rotations to a first preset value; and
a prompter electrically coupled to the controller and controlled by the controller to output a signal when the total number of rotations is greater than the first preset value.

2. The prompting assembly of claim 1, wherein the first preset value is less than or equal to a second preset value.

3. The prompting assembly of claim 2, further comprising a storage configured to store the second preset value and the quantity of rotations.

4. The prompting assembly of claim 1, further comprising a communication unit electrically coupled to the controller; when the total number of rotations is greater than the first preset value, the controller controls the communication unit to transmit a control command to a control center to trigger the control center to transmit a message to a user terminal.

5. The prompting assembly of claim 1, wherein the sensor is a gyroscope.

6. The prompting assembly of claim 1, wherein the prompter is an LED; the signal is a light emitted from the LED.

7. The prompting assembly of claim 1, further comprising a power unit for providing power to the prompting assembly.

8. A toilet paper receptacle comprising:
a spindle configured to hold a roll of toilet paper; and
a prompting assembly comprising:
a sensor located on the spindle and configured to sense a quantity of rotations of the spindle;
a controller electrically coupled to the sensor and configured to calculate a total number of rotations and compare the total number of rotations to a first preset value; and
a prompter electrically coupled to the controller and controlled by the controller to output a signal when the total number of rotations is greater than the first preset value.

9. The toilet paper receptacle of claim 8, wherein the first preset value is less than or equal to a second preset value.

10. The toilet paper receptacle of claim 9, wherein the prompting assembly further comprises a storage configured to store the second preset value and the quantity of rotations.

11. The toilet paper receptacle of claim 8, wherein the prompting assembly further comprises a communication unit electrically coupled to the controller; when the total number of rotations is greater than the first preset value, the controller controls the communication unit to transmit a control command to a control center to trigger the control center to transmit a message to a user terminal.

12. The toilet paper receptacle of claim 8, wherein the sensor is a gyroscope.

13. The toilet paper receptacle of claim 8, wherein the prompter is an LED; the signal is a light emitted from the LED.

14. The toilet paper receptacle of claim 8, wherein the prompting assembly further comprises a power unit for providing power to the prompting assembly.

15. A smart home system comprising:
a control center; and
a prompting assembly in communication with the control center, the prompting assembly comprising;
a sensor configured to sense a quantity of rotations;
a controller electrically coupled to the sensor and configured to calculate a total number of rotations and compare the total number of rotations to a first preset value; and
a prompter electrically coupled to the controller and controlled by the controller to output a signal when the total number of rotations is greater than the first preset value;
wherein when the total number of rotations is greater than the first preset value, the controller controls transmits a control command to the control center, and the control center transmits a message to a user terminal according to the control command.

16. The smart home system of claim 15, wherein the first preset value is less than or equal to a second preset value.

17. The smart home system of claim 16, wherein the prompting assembly further comprises a storage configured to store the second preset value and the quantity of rotations.

18. The smart home system of claim 15, wherein the prompting assembly further comprises a communication unit electrically coupled to the controller to transmit the control command to the control center.

19. The smart home system of claim 15, wherein the sensor is a gyroscope, and the prompter is an LED; the signal is a light emitted from the LED.

20. The smart home system of claim 15, wherein the prompting assembly further comprises a power unit for providing power to the prompting assembly.
